(19) United States
(12) Patent Application Publication
(10) Pub. No.: US 2026/0276168 A1
(43) Pub. Date: Sep. 17, 2026

(54) LIGHTING DEVICE FOR VEHICLES

(71) Applicant: HELLA GMBH & CO. KGAA, Lippstadt (DE)

(72) Inventor: Christopher Reike, Paderborn (DE)

(21) Appl. No.: 19/560,923

(22) Filed: Mar. 9, 2026

(30) Foreign Application Priority Data
Mar. 13, 2025 (DE) 102025109567.1

(51) Int. Cl. F21S 43/249; F21S 43/14; F21S 43/245

(52) U.S. Cl. CPC F21S 43/249; F21S 43/14; F21S 43/245

(57) ABSTRACT

The invention relates to a vehicle lighting device including a first lighting unit for generating a first light function and a second lighting unit for generating a second light function. The first lighting unit includes a flat light guide having opposing flat sides between which coupled light is totally internally reflected in a light-guiding direction, and a narrow side connecting the flat sides through which light from at least one light source is coupled into the light guide. The second lighting unit is arranged downstream of the first lighting unit in a main emission direction. Light emitted by the second lighting unit passes through the flat sides of the light guide and is emitted in the main emission direction. The second lighting unit is positioned, in projection onto a normal of the light guide, in an edge region of the light guide and/or outside the edge region, and includes optical elements such that the emitted light passes through a light transmission surface greater than 50% of a total surface area of the flat light guide.

### CROSS-REFERENCE TO RELATED APPLICATIONS

This application claims the benefit of German Patent Application 10-2025-109-567.1, filed Mar. 13, 2025, the disclosure of which is incorporated by reference in its entirety.

### FIELD OF THE INVENTION

The invention relates to a lighting device for vehicles having a first lighting unit for generating a first light function and a second lighting unit for generating a second light function, wherein the first lighting unit has a flat light guide with opposing flat sides on which coupled-in light is totally internally reflected in a light guiding direction within the flat light guide, and having a narrow side connecting the flat sides on which light generated by the light source can be coupled into the flat light guide, and wherein the second lighting unit is arranged behind the first lighting unit in the main emission direction, wherein light emitted by the second lighting unit passes through the flat sides of the flat light guide and is emitted in the main emission direction.

### BACKGROUND OF THE INVENTION

DE 10-2023-108-470 A1 discloses a lighting device for vehicles having an area light guide that has opposing flat sides extending parallel to one another and narrow sides connecting the flat sides. A light source is arranged on one narrow side so that light is coupled into the flat light guide on this narrow side. This coupled-in light is transmitted to the opposite flat sides of the flat light guide in the direction of light emission by total internal reflection. The flat light guide has a micro-optical structure on a front flat side in the main emission direction, so that the coupled-in light is coupled out in a scattering manner on this front flat side. A reflective surface is arranged on the rear side of the flat light guide such that light coupled out on the rear side is reflected back again and can be used for the light function.

DE 10-2013-105-153 A1 discloses a lighting device for vehicles that has a first lighting unit for generating a first light function and a second lighting unit for generating a second light function. The first lighting unit has a flat light guide having opposing flat sides and narrow sides connecting the opposing flat sides. Light is coupled in on one narrow side of the flat light guide and is totally internally reflected on the flat sides of the flat light guide in the light guiding direction. In some areas, the flat light guide has coupling-out elements on its rear flat side in the main emission direction, so that coupled-in light impinging on them in a targeted manner is deflected in the direction of a front flat side serving as a light coupling-out surface, so that it can exit the flat light guide. These coupling-out elements are arranged in several spaced-apart sections of the rear flat side. Between these sections, uncoupled sections are provided that serve as light passage sections for the passage of light generated by the second lighting unit. The second lighting unit is arranged behind the flat light guide in the main emission direction and can have a light source and a reflector. A disadvantage of the known lighting device is that the second lighting unit is visible to an observer from the outside due to the arrangement behind the flat light guide. Furthermore, the luminous efficacy of the second lighting unit is limited since a portion of the emitted light is absorbed by the sections of the rear flat side of the flat light guide provided with coupling-out elements.

### SUMMARY OF THE INVENTION

The object of the present invention is therefore to further develop a lighting device for vehicles such that several light functions are provided, wherein a homogeneous and flat light-emitting surface is formed with a homogeneous appearance.

To achieve this object, the second lighting unit is arranged in projection to a normal of the flat light guide in an edge region thereof and/or outside the edge region thereof in that the second lighting unit has optical means such that the light generated by a light source of the second lighting unit passes through a light transmission surface of the flat light guide that is greater than 50% of a total surface area of the flat light guide.

The particular advantage of the invention is that a light-emitting surface with a homogeneous appearance is provided both for a first light function and for a second light function, which is free of illuminated sections with different illuminated graphics. The basic idea of the invention is to use coupled-in light from a flat light guide for a first light function, on the one hand, and to use the backlighting of the flat light guide via a closed and continuous surface for generating a second light function, on the other hand. The flat light guide has a homogeneous structure and/or the same surface over its entire surface (front flat side and rear flat side), such that a homogeneous appearance of an illuminated surface is created. The same surface sections or surface regions of the flat light guide are therefore used for the passage of light refracted at the flat light guide (generation of the second light function) and for coupling-out of totally internally reflected light (generation of the first light function).

According to a preferred embodiment of the invention, the majority of the flat light guide surface is used to generate the first and second light functions. Preferably, a light transmission surface for generating the second light function on a rear flat side of the flat light guide is smaller than a total internal reflection surface of the rear flat side such that the total illumination surface area of the first light function is larger than that of the second lighting unit.

According to a further development of the invention, a range of angles of incidence of the light emitted for the second light function onto the rear flat side of the flat light guide is smaller than a critical angle of total internal reflection. This ensures that all the light emitted by the second lighting unit passes through the flat light guide and can be used for generating the second light function.

According to a further development of the invention, an optical means of the second lighting unit is designed such that the light emitted by the second lighting unit passes onto a single light transmission surface of the flat light guide. The light transmission surface is therefore closed or continuous such that a uniform appearance of the second light function is created.

According to a further development of the invention, the flat light guide has no micro-optical elements or no coupling-out elements. The light from the first lighting unit is thus coupled out solely due to the total internal reflection on the rear flat side and the refraction on the front flat side.

According to a further development of the invention, in order to increase the homogeneity of the illuminated surface for generating the first light function and the second light function, for example, the front flat side of the flat light guide can have optics with scattering optical elements. These scattering optical elements are evenly distributed over the entire surface of the front flat side of the flat light guide such that the overall homogeneous appearance is maintained.

According to a further development of the invention, the optical means of the second lighting unit has such a width and/or has such a minimum distance from the flat light guide that the light of the second lighting unit deflected by the optical means strikes at least 50% of the total surface area of the flat light guide. This ensures that a relatively large surface area of the flat light guide can be used for the light to pass through the second lighting unit.

According to a further development of the invention, the optical means of the second light unit is arranged in a first opening of a shielding wall and an edge region of the flat light guide facing the light source of the first light unit is arranged in a second opening of the same shielding wall. This ensures that the light sources of the first and second lighting units and the optical means of the second lighting unit are arranged in a concealed manner. Only the flat light guide is visible to an observer from the outside.

According to a further development of the invention, the optical means is designed as a Fresnel optical element having a plurality of prisms, which can be arranged flat in the first opening of the shielding wall. This has the advantage of providing homogeneous light deflection in the direction of the flat light guide.

According to a further development of the invention, the light sources of the first lighting unit and of the second lighting unit are arranged on a common printed circuit board that is concealed by the shielding wall. The advantage of this is that the light can be generated cost-effectively and in a material-saving manner.

According to a further development of the invention, the flat light guide is formed to be light-transparent and/or glass-clear. Since the flat light guide projects into a cavity in the housing of the lighting device, a lighting device having a depth effect is created.

According to a preferred embodiment of the invention, the first lighting unit is used to generate a tail light function. The second lighting unit is used to generate a brake light function, wherein both the light sources of the first lighting unit and the second lighting unit are switched on when the brake light function is switched on. In this case, the second lighting unit serves as light amplification for the first lighting unit, wherein the same coloring of the two light functions can be used.

According to a further development of the invention, the flat light guide projects into a cavity of the housing of the lighting device, which is surrounded or delimited by the shielding wall, a design trim arranged substantially behind the flat light guide, and a transparent cover lens arranged in front of the flat light guide. This gives the lighting device an advantageous spatial appearance.

### BRIEF DESCRIPTION OF THE DRAWING

An exemplary embodiment of the invention is explained in more detail in the figure below, in which:

FIG. 1 shows a schematic cross-section of a lighting device.

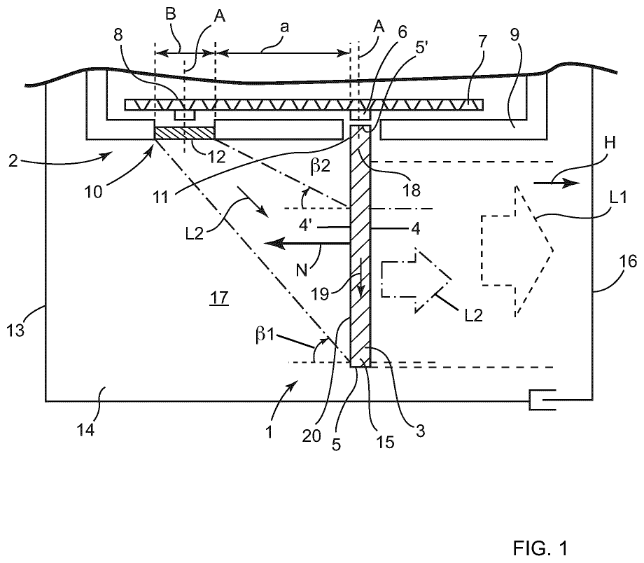

### DETAILED DESCRIPTION

A lighting device according to the invention can be arranged in a rear or front region of a vehicle and is used to generate at least two light functions.

According to the figure, a first lighting unit 1 is provided for generating a first light function and a second lighting unit 2 is provided for generating a second light function.

The first lighting unit 1 has a flat light guide 3 that has opposing flat sides 4, 4′ and narrow sides 5 connecting them. At least one of the narrow sides 5′ serves as a light coupling surface for light L1 emitted by a light source 6 of the first lighting unit 1.

For example, several light sources 6 can be arranged in a row and/or in a straight line and/or in an arc on a printed circuit board 7. Preferably, the multiple light sources 6 are arranged following the contours of the light coupling surface 5′ of the flat light guide 3. If the flat light guide 3 is formed flat with a straight light coupling surface 5, the light sources 6 are also arranged in a straight line at a predetermined distance from one another.

The flat light guide 3 is formed to be light-transparent and/or glass-clear. In any case, it is designed to be translucent for backlighting.

The second lighting unit 2 is arranged behind the first lighting unit 1 in a main emission direction H of the lighting device. The second lighting unit 2 comprises a number of light sources 8 that are preferably arranged on the same printed circuit board 7 as the light sources 6 of the first lighting unit 1. In the present exemplary embodiment, the printed circuit board 7 is formed flat such that the light sources 8 of the second lighting unit 2 are arranged offset relative to the light sources 6 of the first lighting unit 1 counter to the main emission direction H.

Axes A of the light source 6 of the first lighting unit 1 and of the light source 8 of the second lighting unit 2 run perpendicular to a normal N of the flat light guide 3.

The printed circuit board 7 is covered by an light-impermeable shielding wall 9, wherein a first opening 10 is provided for the light L2 emitted by the light source 8 of the second lighting unit 2 to pass through and a second opening 11 is provided for the light L1 emitted by the light source 6 of the first lighting unit 1 to pass through.

A Fresnel optical element 12 that has a plurality of prisms that are not shown is positioned in the first opening 10 of the shielding wall 9 as an optical means of the second lighting unit 2. In the present exemplary embodiment, the Fresnel optical element 12 extends perpendicular to the axis A of the light source 8 and parallel to the normal N of the flat light guide 3.

In the main emission direction H behind the first lighting unit 1 and the second lighting unit 2, a rear wall 13 of a design trim 14 extends in an arc from a rear region of the shielding wall 9 while enclosing an edge region 15 of the flat light guide 3 that does not have the narrow sides 5 associated with the light source 6, such that a pot-shaped housing is formed by the shielding wall 9 and the design trim 14. One opening of this housing is closed by a transparent cover lens 16. Only the flat light guide 3 protrudes into a cavity 17 formed by the housing (shielding wall 9 and design trim 14) and the cover lens 16.

The second lighting unit 2 does not protrude into the cavity 17. In the present exemplary embodiment, the second lighting unit 2 with its optical means 12 is arranged recessed in the main emission direction H relative to an edge region 18 of the flat light guide 3 facing the light source 6. The optical means 12 is thus arranged in projection onto the normal N of the flat light guide 3 in the edge region 18 thereof.

According to an alternative embodiment of the invention that is not shown, the light source of the second lighting unit 2 could be arranged on a separate printed circuit board such that the light source of the second lighting unit 2 and the optical means 12 are arranged recessed relative to the shielding wall 9 compared to the figure. In such an embodiment, the second lighting unit 2 or the optical means 12 would be arranged in projection onto the normal N of the flat light guide 3 outside the edge region 18.

According to a further embodiment of the invention that is not shown, the optical means 12 can be arranged raised relative to the shielding wall 9, wherein it projects beyond the surface of the shielding wall 9 facing the cavity 17. However, a portion of the optical means 12 is always arranged in the first opening 10. The edge region 18 of the flat light guide 3 facing the light source 6 of the first lighting unit 1 is therefore not limited to the arrangement within the second opening 11, but can extend into the cavity 17. This would also be the case if, for example, the light source 6 of the first lighting unit 1 were arranged inside the second opening 11 of the shielding wall 9.

The light L1 generated by the light source 6 of the first lighting unit 1 is coupled into the flat light guide 3 at the coupling surface 5′ and is transmitted by total internal reflection on a front flat side 4 and a rear flat side 4′ of the flat light guide 3 in a light guiding direction 19.

According to a first embodiment of the invention, the flat light guide 3 has scattering optical elements, for example on the front flat side 4 or on the rear flat side 4′ or within the flat light guide 3. This allows the coupled-in light to be redirected in a more targeted manner and/or a scattering of the light coupled out from the flat light guide 3 to be generated. This scattering effect can also be used for generating the light function produced by the second lighting unit 2 when the light from the second lighting unit 2 passes through the flat light guide 3.

The optical means 12 is designed in such a way that the light L2 generated by the light source 8 of the second lighting unit 2 is deflected at an acute angle in the direction of the flat light guide 3 arranged in front of the second lighting unit 2 in the main emission direction H. The light L2 deflected by the optical means 12 strikes a light transmission surface 20 of the flat light guide 3 that is larger than 50% of a total surface area of the flat light guide 3. The light transmission surface 20 is formed by a portion of the rear flat side 4′ of the flat light guide 3 that is smaller than the total surface area of the rear flat side 4′. At a minimum, the light transmission surface 20 has a surface area that is greater than 50% of the surface area of the rear flat side 4′. Preferably, the light transmission surface 20 has an area that is greater than 75%, in particular greater than 80%, of the total surface area of the flat light guide 3 or of the total surface area of the rear flat side 4′ of the flat light guide 3.

A distance a between the first opening 10 and the second opening 11 of the shielding wall 9 or of the optical means 12 relative to the flat light guide 3 is selected such that the light bundle L2 deflected by the optical means 12 impinges on the intended light transmission surface 20 of the flat light guide 3. The further the optical means 12 is from the flat light guide 3, the larger the area of the rear flat side 4′ that is backlit by the second lighting unit

Furthermore, the optical means 12 has such a width B or extension perpendicular to the flat light guide 3 that the deflected light L2 strikes the rear flat side 4′ of the flat light guide 3 at such an angle of incidence β1, β2 that it can pass through the flat light guide 3 by refraction at the rear flat side 4′ of the flat light guide 3 and then by refraction at the front flat side 4 for generating the second light function. The optical means 12 has the minimum width B that ensures that the light beams L2 do not strike the flat light guide 3 too flat, with the undesirable effect that total internal reflection occurs. The angles of incidence β1, β2 or an angle of incidence range of the deflected light L2 are therefore always smaller than a critical angle of total internal reflection on the flat light guide 3.

As can be seen from the figure, there is a single closed and continuous light transmission surface 20 of the flat light guide 3 that is illuminated by the conical light beam L2 of the second lighting unit 2.

The design trim 14 can have a black surface, for example. Alternatively, the design trim 14 can also have a reflective surface. It does not contribute to generating the light function produced by the second lighting unit 2.

For example, the first lighting unit 1 can be used to generate a tail light function when the lighting device is arranged in a rear region of the vehicle. For this purpose, the light sources 6 of the first lighting unit 1 can emit light of red color. The flat light guide 3 can be colored red. Alternatively, it can also be formed glass-clear. After the light L1 emitted by the light source 6 is coupled into the light coupling surface 5′ of the flat light guide 3, total internal reflection occurs at the rear flat side 4′ and at the front flat side 4 until the coupled-in light is coupled out as a light bundle L1 in a planar manner at the front flat side 4 (light out-coupling surface). The light out-coupling surface can correspond to a portion of the front flat side 4 protruding from the shielding wall 9.

To generate a brake light function, the light source 8 of the second lighting unit 2 is also switched on such that after the light bundle L2 generated by the second lighting unit 2 passes through the flat light guide 3 in the main emission direction H, the first light bundle L1 and L2 are superimposed with a higher illuminance that meets the requirements of the brake light function.

According to an alternative embodiment of the invention that is not shown, the first lighting unit 1 can be used to generate a daytime running light function when the lighting device is located in the front region of the vehicle. The second lighting unit 2 can be used to generate a direction indicator function. For this purpose, the light source 8 emits light of yellow color. To generate the direction indicator function, only the light sources 8 of the second lighting unit 2 are switched on, while the light source 6 of the first lighting unit 1 is switched off. The light source 6 of the first lighting unit 1 emits light of white color. In this embodiment, the flat light guide 3 is formed glass-clear such that light of white color is emitted for the daytime running light function and light of yellow color is emitted for the direction indicator function.

The light sources 6, 8 of the two lighting units 1, 2 are designed as LED light sources.

According to an alternative embodiment of the invention, the flat light guide 3 can have no scattering optical element such that the surfaces of the rear flat side 4′ and of the front flat side 4 are formed flat and smooth.

### LIST OF REFERENCE SYMBOLS

1 first lighting unit
2 second light unit
3 flat light guide
4, 4′ front and rear flat sides
5, 5′ narrow sides
6 light source
7 printed circuit board
8 light source
9 shielding wall
10 first opening
11 second opening
12 Fresnel optical element
13 rear wall
14 design trim
15 edge region
16 cover lens
17 cavity
18 edge region
19 light guiding direction
20 light transmission surface
H main emission direction
L1, L2 light
N normal
A axis
B minimum width
A Minimum Distance

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a vehicle, comprising:
a first lighting unit configured to generate a first light function, the first lighting unit including a flat light guide having opposing flat sides on which coupled-in light is totally internally reflected in a light-guiding direction within the flat light guide, and a narrow side connecting the opposing flat sides, the narrow side being configured to couple light generated by at least one light source into the flat light guide; and
a second lighting unit configured to generate a second light function, the second lighting unit being arranged downstream of the first lighting unit in a main emission direction,
wherein light emitted by the second lighting unit passes through the opposing flat sides of the flat light guide and is emitted in the main emission direction,
wherein the second lighting unit is arranged, in projection onto a normal of the flat light guide, in an edge region of the flat light guide or outside the edge region, and
wherein the second lighting unit includes at least one optical element configured such that light generated by a light source of the second lighting unit passes through a light transmission surface of the flat light guide that is greater than 50% of a total surface area of the flat light guide.

2. The lighting device of claim 1, wherein the light transmission surface of the flat light guide is greater than 75% of the total surface area of the flat light guide.

3. The lighting device of claim 1, wherein the at least one optical element is configured such that light emitted by the second lighting unit strikes a rear flat side of the flat light guide within an angle of incidence range that is smaller than a critical angle for total internal reflection.

4. The lighting device of claim 1, wherein the at least one optical element is configured such that light emitted by the second lighting unit strikes only a single light transmission surface of the flat light guide.

5. The lighting device of claim 1, wherein the flat light guide includes scattering optical elements on a front flat side and/or a rear flat side or within the flat light guide.

6. The lighting device of claim 1, wherein the flat light guide is free of scattering optical elements.

7. The lighting device of claim 1, wherein the at least one optical element has a minimum width and/or is spaced from the flat light guide by a minimum distance such that light of the second lighting unit deflected by the at least one optical element strikes at least 50% of a total surface area of a rear flat side of the flat light guide.

8. The lighting device of claim 1, wherein the at least one optical element is arranged perpendicular to the flat light guide.

9. The lighting device of claim 1, further comprising a shielding wall having a first opening in which the at least one optical element is arranged and a second opening in which an edge region of the flat light guide is arranged.

10. The lighting device of claim 1, wherein the at least one optical element comprises a planar Fresnel optical element having a plurality of prisms.

11. The lighting device of claim 1, wherein a light source of the first lighting unit and a light source of the second lighting unit are arranged on a common printed circuit board.

12. The lighting device of claim 1, wherein the flat light guide is light-transparent.

13. The lighting device of claim 1, wherein a light source of the first lighting unit and a light source of the second lighting unit each comprise a light-emitting diode configured to emit red light, and wherein the lighting device is configured such that activation of the light source of the first lighting unit generates a tail light function and activation of both the light source of the first lighting unit and the light source of the second lighting unit generates a brake light function.

14. The lighting device of claim 1, further comprising a design trim arranged behind the flat light guide in the main emission direction and extending forward while enclosing the flat light guide to form a pot-shaped housing.

15. The lighting device of claim 1, wherein the flat light guide is arranged substantially within a cavity formed by a pot-shaped housing, and wherein one opening of the housing is closed by a transparent cover lens.
